(19) United States
(12) Patent Application Publication
(10) Pub. No.: US 2020/0385629 A1
(43) Pub. Date: Dec. 10, 2020

(54) NANOSIZED SCALE INHIBITORS FOR INCREASING OILFIELD SCALE INHIBITION TREATMENT LIFETIME

(71) Applicant: The Texas A&M University System, College Station, TX (US)

(72) Inventors: Jenn-Tai Liang, College Station, TX (US); Huili Guan, College Station, TX (US)

(73) Assignee: The Texas A&M University System, College Station, TX (US)

(21) Appl. No.: 16/770,480

(22) PCT Filed: Dec. 8, 2017
(86) PCT No.: PCT/US2017/065308

§ 371 Date: Jun. 5, 2020

(51) Int. Cl. C09K 8/528; C02F 5/12; E21B 37/06

(52) U.S. Cl. CPC C09K 8/528; C02F 5/125; C02F 2103/10; C09K 2208/10; E21B 37/06

(57) ABSTRACT

The present disclosure provides nanosized scale inhibitors (NSI) that can extend a well treatment lifetime with high scale inhibitor retention and the ability to provide slow and sustained scale inhibitor release. The NSI can be in the form of particles where the particle size is in the nanometer range, the NSI can be suitable for applications in both formation rock and fractures. During hydraulic fracturing, the NSI can be mixed and pumped with the fracturing fluid into formation rock and fractures as a one-step process to cut the treatment cost, and the NSI can penetrate readily into the secondary fracture networks created in tight shale formations.

### BACKGROUND

Scaling is a problem in oilfield production environments where insoluble inorganic salts, such as barium sulfate, strontium sulfate, calcite, etc., form when the equilibrium of the fluids in a formation is disturbed, or when two incompatible brines mix. Downhole scale formation is one of the major flow assurance issues that can result in the blockage of the formation rock in the near-wellbore region and that can cause damage to the production facilities.

To mitigate the problem, water-soluble chemical scale inhibitors are often injected (or “squeezed”) into the formation rock via production wells. Once back on production, the scale inhibitor is washed out of the formation rock with the produced brine. When the scale inhibitor concentration in the produced brine drops below a certain threshold concentration called minimum inhibitor concentration (MIC), the squeeze treatment must be repeated. Scale inhibitor squeezes are expensive in terms of material, equipment, and time lost to production. Therefore, there are strong practical and financial incentives to reduce the retreatment frequency by increasing the treatment lifetime.

A main problem with the chemical squeeze method is that a majority (e.g., 80 to 90%) of injected scale inhibitor is produced back with the brine within days after treatment. Thus, a small amount of scale inhibitor retained in the formation rock is relied upon to inhibit scale formation. Large treatment volumes are therefore often required to achieve the desired treatment lifetime. However, the resulting long flow-back time of the injected water soluble scale inhibitor solution can defer oil production and can damage the hydrocarbon productivity as a result of clay mobilization and the relative permeability effect caused by water block in the near wellbore area.

Pseudo-scale formation due to the incompatibility of the field brine and the selected scale inhibitors is another potential source of formation damage. As used herein, pseudo-scale is the precipitation of the scale inhibitor itself when the scale inhibitor contacts the Ca²⁺ and Mg²⁺ ions in the formation brine. Therefore, it is important to verify that the inhibitors selected are compatible with the field brine.

Without wishing to be bound by theory, it is believed that an effective way to increase the treatment lifetime is to minimize scale inhibitor washout by increasing the retention of scale inhibitors in the formation rock. Various approaches have been proposed in an attempt to increase the scale inhibitor retention. One approach is to pretreat the formation rock with chemicals to increase the adsorption of the subsequently injected scale inhibitors on the treated rock surface. However, the added costs and treatment time associated with the injection of the chemicals and shut-in periods render this process uneconomical. Furthermore, due to the complex downhole conditions and reservoir heterogeneity, the pretreatment process may not work as expected. Another approach is called “precipitation squeeze” where low solubility solid particulates formed by complexing the scale inhibitors with Ca²⁺ or Zn²⁺ ions are injected into the formation to enhance scale-inhibitor retention. The slow dissolution of the low solubility scale-inhibitor particulates could then provide improved treatment lifetime. However, this method can cause formation damage due to the injected particulates.

Other approaches targeting fractures and/or the production strings include the use of encapsulated scale inhibitors (ESI) or solid particles coated/impregnated with scale inhibitors. These products rely on the slow release or gradual dissolution of the scale inhibitor to increase the treatment lifetime. The ESI are hollow particles with membrane-type polymeric shell to allow slow release of encapsulated scale inhibitor. For example, the ESI can include porous ceramic proppants impregnated with solid scale inhibitors, which can be pumped with the regular proppants during hydraulic fracturing operations. After the fractured well is returned to production, the produced brine would then slowly dissolve the impregnated scale inhibitor, thereby achieving increased treatment life time. Regular proppants coated with solid scale inhibitors can also be used for the same purpose. The particle size of these products is usually in the micron or the millimeter range and therefore, they are suitable only for wide fracture or production string applications. Furthermore, due to the relatively large particle size, the ESI cannot be placed in the small secondary fracture networks that are critical for the hydrocarbon productivity in unconventional tight shale formations.

The scale inhibition treatment lifetime is highly dependent on the rate and volume of brine produced after treatment. Without wishing to be bound by theory, it is believed that for a given treatment size, higher brine throughput and large volumes of produced brine translate into shortened treatment lifetime. Therefore, a meaningful indicator for treatment lifetime is not “elapsed time” but “brine throughput,” which can be measured as the number of pore volumes of brine produced when the scale inhibitor concentration in the produced brine drops below MIC.

There is a need for nanosized scale inhibitors (NSI) that can extend the treatment lifetime with high scale inhibitor retention and the ability to provide slow and sustained scale inhibitor release. The present disclosure seeks to fulfill these needs and provides further related advantages.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, the present disclosure features a composition, including a liquid; and crosslinked polymeric scale inhibitor particles suspended in the liquid, wherein the crosslinked polymeric scale inhibitor particles include: a polymer synthesized from at least a monomer selected from (alkyl)acrylic acid monomers, hydroxyalkyl (alkyl)acrylate phosphonate monomers, hydroxyalkyl (alkyl)acrylate phosphate monomers, α,β-unsaturated carboxylic acid, α,β-unsaturated esters, α,β-unsaturated anhydrides, brine-compatible monomers, salts thereof, and any combination thereof; and a crosslinker linked to the polymer via hydrolyzable bonds. The composition is configured to inhibit scale formation in a formation rock in an oil and gas field.

In another aspect, the present disclosure features a method of inhibiting scale formation in a formation rock in an oil or gas field, including injecting an aqueous suspension of crosslinked polymeric scale inhibitor particles into the formation rock, wherein the crosslinked polymeric scale inhibitor includes a polymer synthesized from at least a monomer selected from (alkyl)acrylic acid monomers, hydroxyalkyl (alkyl)acrylate phosphonate monomers, hydroxyalkyl (alkyl)acrylate phosphate monomers, α,β-unsaturated carboxylic acid, α,β-unsaturated esters, α,β-unsaturated anhydrides, brine-compatible monomers, salts thereof, and any combination thereof; and a crosslinker linked to the polymer via hydrolyzable bonds. The aqueous suspension of crosslinked polymeric scale inhibitor particles inhibits scale formation in the formation rock in the oil and gas field.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is graph showing a release profile for an embodiment of a crosslinked polymeric scale inhibitor particle of the present disclosure.

FIG. 2 is graph showing a release profile for an embodiment of a crosslinked polymeric scale inhibitor particle of the present disclosure.

FIG. 3 is graph showing a release profile for an embodiment of a crosslinked polymeric scale inhibitor particle of the present disclosure.

FIG. 4 is a graph showing percent retention of embodiments of crosslinked polymeric scale inhibitor particles of the present disclosure.

### DETAILED DESCRIPTION

The present disclosure provides nanosized scale inhibitors (NSI) that can extend a well treatment lifetime with high scale inhibitor retention and the ability to provide slow and sustained scale inhibitor release. The NSI are formed of crosslinked polymeric scale inhibitors, where the crosslinking bonds are subject to hydrolysis. Upon hydrolysis, the crosslinking bonds cleave to release linear polymeric scale inhibitors in a gradual manner, such that the linear polymeric scale inhibitors can be released over a period of time to inhibit scale formation. The NSI can be in the form of particles where the particle size is in the nanometer or micrometer range, and can be suitable for applications in both formation rock and fractures.

During hydraulic fracturing, the NSI can be mixed and pumped with the fracturing fluid into formation rock and fractures as a one-step process to cut the treatment cost, and the NSI can readily penetrate into the secondary fracture networks created in tight shale formations. Furthermore, because the release mechanism of scale inhibitors of the present disclosure is controlled by hydrolysis of NSI retained in formation rock and not by dissolution, the treatment lifetime can be less dependent on brine throughput, when compared to non-crosslinked polymeric scale inhibitors, which can translate into longer treatment lifetime with less retreatment frequency in high throughput wells.

In some embodiments, when an NSI is synthesized using inverse emulsion polymerization, the NSI can be injected directly into water-sensitive formation rock without breaking the water-in-oil emulsion, which can minimize potential hydrocarbon productivity damage due to the relative permeability effect that can be caused by non-crosslinked water soluble scale inhibitors.

The NSI of the present disclosure can target most oilfield scales and be compatible with brines containing high Ca²⁺ and Mg²⁺ concentrations.

### Definitions

At various places in the present specification, substituents of compounds of the disclosure are disclosed in groups or in ranges. It is specifically intended that the disclosure include each and every individual subcombination of the members of such groups and ranges. For example, the term “C₁₋₆ alkyl” is specifically intended to individually disclose methyl, ethyl, C₃ alkyl, C₄ alkyl, C₅ alkyl, and C₆ alkyl.

It is further intended that the compounds of the disclosure are stable. As used herein “stable” refers to a compound that is sufficiently robust to survive isolation to a useful degree of purity from a reaction mixture.

It is further appreciated that certain features of the disclosure, which are, for clarity, described in the context of separate embodiments, can also be provided in combination in a single embodiment. Conversely, various features of the disclosure which are, for brevity, described in the context of a single embodiment, can also be provided separately or in any suitable subcombination.

“Optionally substituted” groups can refer to, for example, functional groups that may be substituted or unsubstituted by additional functional groups. For example, when a group is unsubstituted, it can be referred to as the group name, for example alkyl or aryl. When a group is substituted with additional functional groups, it may more generically be referred to as substituted alkyl or substituted aryl.

As used herein, the term “substituted” or “substitution” refers to the replacing of a hydrogen atom with a substituent other than H. For example, an “N-substituted piperidin-4-yl” refers to replacement of the H atom from the NH of the piperidinyl with a non-hydrogen substituent such as, for example, alkyl.

As used herein, the term “alkyl” refers to a straight or branched hydrocarbon groups. In some embodiments, alkyl has 1 to 10 carbon atoms (e.g., 1 to 8 carbon atoms, 1 to 6 carbon atoms, 1 to 3 carbon atoms, 1 or 2 carbon atoms, or 1 carbon atom). Representative alkyl groups include methyl, ethyl, propyl (e.g., n-propyl, isopropyl), butyl (e.g., n-butyl, sec-butyl, and tert-butyl), pentyl (e.g., n-pentyl, tert-pentyl, neopentyl, isopentyl, pentan-2-yl, pentan-3-yl), and hexyl (e.g., n-hexyl and isomers) groups.

As used herein, the term “alkylene” refers to a linking alkyl group.

As used herein, the term “cycloalkyl” refers to non-aromatic carbocycles including cyclized alkyl, alkenyl, and alkynyl groups. Cycloalkyl groups can include mono- or polycyclic (e.g., having 2, 3 or 4 fused rings) ring systems, including spirocycles. In some embodiments, cycloalkyl groups can have from 3 to about 20 carbon atoms, 3 to about 14 carbon atoms, 3 to about 10 carbon atoms, or 3 to 7 carbon atoms. Cycloalkyl groups can further have 0, 1, 2, or 3 double bonds and/or 0, 1, or 2 triple bonds. Also included in the definition of cycloalkyl are moieties that have one or more aromatic rings fused (i.e., having a bond in common with) to the cycloalkyl ring, for example, benzo derivatives of pentane, pentene, hexane, and the like. A cycloalkyl group having one or more fused aromatic rings can be attached though either the aromatic or non-aromatic portion. One or more ring-forming carbon atoms of a cycloalkyl group can be oxidized, for example, having an oxo or sulfido substituent. Example cycloalkyl groups include cyclopropyl, cyclobutyl, cyclopentyl, cyclohexyl, cycloheptyl, cyclopentenyl, cyclohexenyl, cyclohexadienyl, cycloheptatrienyl, norbomyl, norpinyl, norcamyl, adamantyl, and the like.

As used herein, the term “cycloalkylene” refers to a linking cycloalkyl group. As used herein, the term “aryl” refers to an aromatic hydrocarbon group having 6 to 10 carbon atoms. Representative aryl groups include phenyl groups. In some embodiments, the term “aryl” includes monocyclic or polycyclic (e.g., having 2, 3, or 4 fused rings) aromatic hydrocarbons such as, for example, phenyl, naphthyl, anthracenyl, phenanthrenyl, indanyl, and indenyl.

As used herein, the term “arylene” refers to a linking aryl group.

As used herein, the term “halogen” or “halo” refers to fluoro, chloro, bromo, and iodo groups.

As used herein, the term “polymer” refers to a macromolecule having at least 10 repeating units.

As used herein, the term “oligomer” refers to a molecule having 2 to 9 repeating units.

As used herein, the term “copolymer” refers to a polymer that is the result of polymerization of two or more different monomers. The number and the nature of each constitutional unit can be separately controlled in a copolymer. The constitutional units can be disposed in a purely random, an alternating random, a regular alternating, a regular block, or a random block configuration unless expressly stated to be otherwise. A purely random configuration can, for example, be: x-x-y-z-x-y-y-z-y-z-z-z . . . or y-z-x-y-z-y-z-x-x . . . . An alternating random configuration can be: x-y-x-z-y-x-y-z-y-x-z . . . , and a regular alternating configuration can be: x-y-z-x-y-z-x-y-z . . . . A regular block configuration (i.e., a block copolymer) has the following general configuration: . . . x-x-x-y-y-y-z-z-z-x-x-x . . . , while a random block configuration has the general configuration: . . . x-x-x-z-z-x-x-y-y-y-y-z-z-z-x-x-z-z-z- . . . .

As used herein, the term “random copolymer” is a copolymer having an uncontrolled mixture of two or more constitutional units. The distribution of the constitutional units throughout a polymer backbone (or main chain) can be a statistical distribution, or approach a statistical distribution, of the constitutional units. In some embodiments, the distribution of one or more of the constitutional units is favored.

As used herein, the term “constitutional unit” of a polymer refers to an atom or group of atoms in a polymer, comprising a part of the chain together with its pendant atoms or groups of atoms, if any. The constitutional unit can refer to a repeating unit. The constitutional unit can also refer to an end group on a polymer chain. For example, the constitutional unit of polyethylene glycol can be —CH₂CH₂O— corresponding to a repeating unit, or —CH₂CH₂OH corresponding to an end group.

As used herein, the term “repeating unit” corresponds to the smallest constitutional unit, the repetition of which constitutes a regular macromolecule (or oligomer molecule or block).

As used herein, the term “end group” refers to a constitutional unit with only one attachment to a polymer chain, located at the end of a polymer. For example, the end group can be derived from a monomer unit at the end of the polymer, once the monomer unit has been polymerized. As another example, the end group can be a part of a chain transfer agent or initiating agent that was used to synthesize the polymer.

As used herein, the term “terminus” of a polymer refers to a constitutional unit of the polymer that is positioned at the end of a polymer backbone.

As used herein, the term “cationic” refers to a moiety that is positively charged, or ionizable to a positively charged moiety under physiological conditions. Examples of cationic moieties include, for example, amino, ammonium, pyridinium, imino, sulfonium, quaternary phosphonium groups, etc.

As used herein, the term “anionic” refers to a functional group that is negatively charged, or ionizable to a negatively charged moiety under physiological conditions. Examples of anionic groups include carboxylate, sulfate, sulfonate, phosphate, etc.

As used herein, the term “brine” refers to a saline liquid usually used in completion operations and/or when penetrating a pay zone. The brine has a higher density than fresh water. Classes of brines include chloride brines (calcium and sodium), bromides and formates. The brine can be water-based solution of inorganic salts used as a well-control fluid during the completion and workover phases of well operations. In some embodiments, brines are solids free, containing no particles that might plug or damage a producing formation. Brines can be formulated and prepared for specific conditions, with a range of salts available to achieve densities ranging from 8.4 to over 20 lbm/gal (ppg) (1.0 to 2.4 g/cm³). Salts used in the preparation of simple brine systems can include sodium chloride, calcium chloride, and potassium chloride. More complex brine systems can contain zinc, bromide, and/or iodine salts.

As used herein, the term “scale” refers to a deposit or coating formed on the surface of metal, rock or other material. Scale can be caused by a precipitation due to a chemical reaction, a change in pressure or temperature, or a change in the composition of a solution. In some embodiments, scale can also refer to a corrosion product. Examples of scale compositions include calcium carbonate, calcium sulfate, barium sulfate, strontium sulfate, iron sulfide, iron oxides, iron carbonate, the various silicates and phosphates and oxides, or any of a number of compounds insoluble or slightly soluble in water.

As used herein, a “scale inhibitor” is a chemical agent used in a treatment for the control or prevention of scale deposition.

As used herein, a “gel” refers to a crosslinked polymer system, which does not flow when in the steady state. The gel can be mostly liquid, but behave like solids due to a three-dimensional cross-linked network within the liquid. The gel can include a dispersion of molecules of a liquid within a solid in which liquid particles are dispersed in the solid medium.

As used herein, a “crosslinker” refers to a molecule that forms covalent bonds between two or more molecules to form a three-dimensional network of connected molecules. Crosslinkers have two or more reactive functional groups capable or chemically attaching to specific functional groups (e.g., primary amines, sulfhydryls, etc). As used herein, the term “consisting essentially of” or “consists essentially of” refers to a composition including the components of which it consists essentially as well as other components, provided that the other components do not materially affect the essential characteristics of the composition. Typically, a composition consisting essentially of certain components will comprise greater than or equal to 95 wt % of those components or greater than or equal to 99 wt % of those components.

Unless otherwise defined, all technical and scientific terms used herein have the same meaning as commonly understood by one of ordinary skill in the art. Although methods and materials similar or equivalent to those described herein can be used in the practice or testing of the present disclosure, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The particulars shown herein are by way of example and for purposes of illustrative discussion of embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice. As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize. All of the references cited herein are incorporated by reference. Aspects of the disclosure can be modified, if necessary, to employ the systems, functions, and concepts of the above references and application to provide yet further embodiments of the disclosure. These and other changes can be made to the disclosure in light of the detailed description.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

### Scale Inhibitors

The present disclosure features a composition that includes a liquid; and crosslinked polymeric scale inhibitor particles suspended in the liquid, wherein the crosslinked polymeric scale inhibitor particles include: a polymer synthesized from at least a monomer selected from (alkyl)acrylic acid monomers, derivatives of (alkyl)acrylic acid (e.g., hydroxyalkyl (alkyl)acrylate phosphonate, hydroxyalkyl (alkyl)acrylate phosphate (e.g., 2-hydroxyethyl acrylate phosphate, 2-hydroxyethyl methacrylate phosphate), mono[2-(acryloyloxyethyl)]succinate, mono[2-(methacryloyloxyethyl)]succinate, mono[2-(acryloyloxyethyl)] maleate, and/or mono[2-(methacryloyloxyethyl)] maleate), α,β-unsaturated carboxylic acid, α,β-unsaturated esters, unsaturated anhydrides (e.g., α,β-unsaturated anhydrides), brine-compatible monomers, salts thereof, and any combination thereof; and a crosslinker linked to the polymer via hydrolyzable bonds, wherein the composition is configured to inhibit scale formation in a formation rock in an oil and gas field. The monomer(s) can be polymerized via addition polymerization reactions such as radical polymerization, ring-opening polymerization, anionic addition polymerization, or cationic addition polymerization. The polymerization of the monomer(s) can further include a chain transfer agent. The crosslinked polymeric scale inhibitor can be a gel in the composition.

In some embodiments, the crosslinker is linked to segments of linear polymer via hydrolyzable bonds, and upon hydrolysis which results in cleavage of the bonds connecting the crosslinker to the linear polymeric segments, the linear polymeric segments are gradually released. The linear polymeric segments can inhibit scale formation.

In some embodiments, the linear polymeric segments in the crosslinked polymeric scale inhibitor have a molecular weight (M_{W}) of 500 or more (e.g., 1,000 or more, 2,500 or more, 5,000 or more, 7,500 or more, 10,000 or more, 15,000 or more, 20,000 or more, or 25,000 or more) and/or 30,000 or less (25,000 or less, 20,000 or less, 15,000 or less, 10,000 or less, 7,500 or less, 5,000 or less, 2,500 or less, or 1,000 or less).

The particles can have an average maximum dimension of 1 nm or more (e.g., 5 nm or more, 50 nm or more, 100 nm or more, 500 nm or more, 1 μm or more, or 50 μm or more) and/or 100 μm or less (e.g., 50 μm or less, 1 μm or less, 500 nm or less, 100 nm or less, 50 nm or less, or 5 nm or less). The average maximum dimension can be measured by dynamic laser light scattering and/or laser diffraction. Without wishing to be bound by theory, it is believed that dynamic laser light scattering calculates average particle size by analyzing the fluctuation of the scattered light caused by the particles in suspension. Dynamic laser light scattering can measure the particle size ranging from 1 nm to several microns. In laser diffraction methods, the particle size can be measured by monitoring the intensity of the light scattered by the particles. Laser diffraction can measure the particle size ranging from hundreds of nanometers to several millimeters.

In some embodiments, the liquid in the composition is aqueous (i.e., includes, or is water). The liquid can include dissolved inorganic salts. In some embodiments, the liquid is brine. The liquid can be substantially free of insoluble material (with the exception of the crosslinked polymeric scale inhibitor particles).

In some embodiments, the (alkyl)acrylic acid monomers and/or salts thereof are independently selected from acrylic acid, methacrylic acid, acrylate salts (e.g., sodium acrylate), methacrylate salts (e.g., sodium methacrylate), ethylacrylic acid, ethylacrylate salts (e.g., sodium ethylacrylate), and any combination thereof. In some embodiments, the alkyl)acrylic acid monomers are independently selected from acrylic acid, methacrylic acid, and combinations thereof. The (alkyl)acrylic acid monomers and salts thereof can represent 50 mol % or more (e.g., 60 mol % or more, 70 mol % or more, 80 mol % or more, or 90 mol % or more) and/or 95 mol % or less (e.g., 90 mol % or less, 80 mol % or less, 70 mol % or less, or 60 mol % or less) of the monomers and crosslinkers forming the total crosslinked polymeric scale inhibitor. As described herein, the various monomers and crosslinkers forming the total crosslinked polymeric scale inhibitor can be present in the given mole percentages, so long as the total mole percent of various monomers and crosslinkers adds to 100 mole percent.

In some embodiments, the derivatives of (alkyl)acrylic acid monomers and/or salts thereof are independently selected from hydroxyalkyl (alkyl)acrylate phosphonate, hydroxyalkyl (alkyl)acrylate phosphate (e.g., 2-hydroxyethyl acrylate phosphate, 2-hydroxyethyl methacrylate phosphate), mono[2-(acryloyloxyethyl)]succinate, mono[2-(methacryloyloxyethyl)]succinate, mono[2-(acryloyloxyethyl)] maleate, mono[2-(methacryloyloxyethyl)] maleate, salts thereof, and any combination thereof. The derivatives of (alkyl)acrylic acid monomers and/or salts thereof (e.g., hydroxyalkyl (alkyl)acrylate phosphonate, hydroxyalkyl (alkyl)acrylate phosphate (e.g., 2-hydroxyethyl acrylate phosphate, 2-hydroxyethyl methacrylate phosphate), mono[2-(acryloyloxyethyl)] succinate, mono[2-(methacryloyloxyethyl)] succinate, mono[2-(acryloyloxyethyl)] maleate, mono[2-(methacryloyloxyethyl)] maleate, salts thereof) and any combination thereof can represent 50 mol % or more (e.g., 60 mol % or more, 70 mol % or more, 80 mol % or more, or 90 mol % or more) and/or 95 mol % or less (e.g., 90 mol % or less, 80 mol % or less, 70 mol % or less, or 60 mol % or less) of the monomers and crosslinkers forming the total crosslinked polymeric scale inhibitor.

In some embodiments, the crosslinked polymeric scale inhibitor particles include a polymer synthesized from at least 2-methacrylamido-2-methyl-1-propanesulfonic acid. In some embodiments, the crosslinked polymeric scale inhibitor particles include a polymer synthesized from at least methacrylic acid.

In some embodiments, the α,β-unsaturated carboxylic acids and salts thereof are independently selected from selected from maleic acid, salts thereof, and combinations thereof. In some embodiments, the α,β-unsaturated carboxylic acid is maleic acid. The α,β-unsaturated carboxylic acids and/or salts thereof can represent 50 mol % or more (e.g., 60 mol % or more, 70 mol % or more, 80 mol % or more, or 90 mol % or more) and/or 95 mol % or less (e.g., 90 mol % or less, 80 mol % or less, 70 mol % or less, or 60 mol % or less) of the monomers and crosslinkers forming the total crosslinked polymeric scale inhibitor.

In some embodiments, the unsaturated anhydride (e.g., the α,β-unsaturated anhydride) is maleic anhydride. The unsaturated anhydride can represent 50 mol % or more (e.g., 60 mol % or more, 70 mol % or more, 80 mol % or more, or 90 mol % or more) and/or 95 mol % or less (e.g., 90 mol % or less, 80 mol % or less, 70 mol % or less, or 60 mol % or less) of the monomers and crosslinkers forming the total crosslinked polymeric scale inhibitor.

In some embodiments, the crosslinked polymeric scale inhibitor includes (alkyl)acrylic acid monomers and salts thereof, α,β-unsaturated carboxylic acids and salts thereof, and/or unsaturated anhydride cumulatively represent 50 mol % or more (e.g., 60 mol % or more, 70 mol % or more, 80 mol % or more, or 90 mol % or more) and/or 95 mol % or less (e.g., 90 mol % or less, 80 mol % or less, 70 mol % or less, or 60 mol % or less) of the monomers and crosslinkers forming the total crosslinked polymeric scale inhibitor.

In some embodiments, when the crosslinked polymeric scale inhibitor includes a brine-compatible monomer, the brine-compatible monomers are each independently selected from monomers that include sulfonic acid groups, hydroxyl functional groups, sulfate groups, ethylene glycol (which polymerizes to poly(ethylene glycol)), and any combination thereof. For example, the brine-compatible monomers and salts thereof can each be independently selected from 2-(alkyl)acrylamide-2-methyl-1-propanesulfonic acid, e.g., 2-methacrylamido-2-methyl-1-propanesulfonic acid, sodium 2-(alkyl)acrylamide-2-methyl-1-propanesulfonate (e.g., sodium 2-methacrylamido-2-methyl-1-propanesulfonate), 2-acrylamido-2-methyl-1-propanesulfonic acid, sodium 2-acrylamido-2-methyl-1-propanesulfonate, methallyl sulfonic acid, 3-allyloxyl-2-hydroxypropanesulfonic acid, 4-(allyloxy)benzenesulfonic acid, para styrene sulfonic acid, ethylene glycol, salts thereof, and any combination thereof. In some embodiments, the brine-compatible monomers is 2-acrylamido-2-methyl-1-propanesulfonic acid. In some embodiments, the brine-compatible monomers represent 5 mol % or more (e.g., 10 mol % or more, 20 mol % or more, 30 mol % or more, 40 mol % or more) and/or 50 mol % or less (e.g., 40 mol % or less, 30 mol % or less, 20 mol % or less, or 10 mol % or less) of the monomers and crosslinkers forming the total crosslinked polymeric scale inhibitors. When incorporated into a polymeric scale inhibitor (crosslinked or not), the brine-compatible repeating unit decreases the likelihood that the polymeric scale inhibitor will form precipitates with the brine components (e.g., salts).

In some embodiments, the crosslinker can be selected from methylene bis(meth)acrylamide, poly(ethylene glycol) di(meth)acrylate, di(meth)acrylamide, poly(ethylene glycol) diacrylamide, dimethacrylamide, and any combination thereof. In some embodiments, the crosslinker is N,N′-methylene bisacrylamide. In some embodiments, the crosslinker is N,N′-methylene bismethacrylamide. The crosslinker can represent 0.1 mol % or more (e.g., 1 mol % or more, 5 mol % or more, 10 mol %, 20 mol % or more) and/or 30 mol % or less (e.g., 20 mol % or less, 10 mol % or less, 5 mol % or less, 1 mol % or less) of the monomers and crosslinkers forming the total crosslinked polymeric scale inhibitors.

In some embodiments, the monomers and crosslinkers forming a crosslinked polymeric scale inhibitor are acrylic acid (AA), 2-(meth)acrylamido-2-methyl-1-propanesulfonic acid sodium salt, and N,N′-methylene bisacrylamide. The polymer can be formed in the presence of thioglycolic acid and 2,2′-azobis(2-methylpropionamidine) dihydrochloride.

The compositions of the present disclosure can further include a linear (i.e., non-crosslinked) polymer synthesized from at least a monomer selected from (alkyl)acrylic acid monomers, α,β-unsaturated carboxylic acid, α,β-unsaturated esters, unsaturated anhydrides (e.g., α,β-unsaturated anhydrides), brine-compatible monomers, salts thereof, and any combination thereof. The linear polymer can have a molecular weight (M_{W}) of 500 or more (e.g., 1,000 or more, 2,000 or more, 4,000 or more, 6,000 or more, 8,000 or more) and/or 10,000 or less (e.g., 8,000 or less, 6,000 or less, 4,000 or less, 2,000 or less, or 1,000 or less).

In some embodiments, the compositions of the present disclosure consists essentially of the liquid and crosslinked polymeric scale inhibitor particles suspended in the liquid, and optionally one or more dissolved salts in the liquid. In certain embodiments, the compositions of the present disclosures consists essentially of the liquid, crosslinked polymeric scale inhibitor particles suspended in the liquid, linear polymer(s) suspended in the liquid, and optionally one or more dissolved salts in the liquid. The liquid, crosslinked polymeric scale inhibitor particles, linear polymer(s), and dissolved salts are as described above.

In some embodiments, the compositions of the present disclosure consists of the liquid and crosslinked polymeric scale inhibitor particles suspended in the liquid, and optionally one or more dissolved salts in the liquid. In certain embodiments, the compositions of the present disclosures consists of the liquid, crosslinked polymeric scale inhibitor particles suspended in the liquid, linear polymer(s) suspended in the liquid, and optionally one or more dissolved salts in the liquid. The liquid, crosslinked polymeric scale inhibitor particles, linear polymer(s), and dissolved salts are as described above.

### Synthesis and Characterization

The crosslinked polymeric scale inhibitors of the present disclosure can be synthesized by solution polymerization and inverse-emulsion polymerization methods. The Example below provides solution polymerization syntheses, which can be readily adapted to inverse-emulsion polymerization processes. During the solution polymerization processes, the properties of the crosslinked polymeric scale inhibitor's composition can be tailored by copolymerization of different monomers in various proportions, for example, to enhance compatibility of the polymeric product with brine. The release of the polymeric scale inhibitor segments from the crosslinked polymeric scale inhibitor is achieved through the hydrolysis of bonds such as ester and/or amide bonds. The rate of scale inhibitor release can be controlled by changing the amount of the hydrolyzable bonds in the crosslinked polymeric scale inhibitor (e.g., by varying the amount of a crosslinker). The molecular weight of the released scale inhibitor can be controlled by adjusting the amount of chain transfer agent during polymerization. After synthesis, the crosslinked scale inhibitor can be ground by a blender to provide particles of a desired size for performance evaluation.

Scheme 1 shows an exemplary polymerization process, where the crosslinkers (XL) can be, for example, poly(ethylene glycol) di(meth)acrylate and/or di(meth)acrylamide; and CTA is a chain transfer agent.

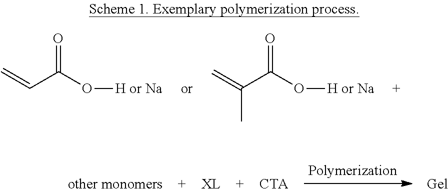

The crosslinked gel can then be rendered to the nanometer or micrometer scale using a blender.

In some embodiments, the crosslinked gel can be synthesized from monomers that include 2-methacrylamido-2-methyl-1-propanesulfonic acid. In some embodiments, the crosslinked gel can be synthesized from monomers that include methacrylic acid.

Once made, static and dynamic adsorption tests can be performed on the crosslinked polymeric scale inhibitors and particles thereof to characterize adsorption of the scale inhibitors on formation rock. Static adsorption tests using a quartz crystal microbalance with dissipation monitoring (QCM-D) can be performed with quartz and carbonate sensors to simulate sandstone and carbonate reservoir rocks. Sand pack experiments can be performed under anaerobic conditions using different flow rates to determine the retention dynamics of the scale inhibitors in porous rock.

The crosslinked polymeric scale inhibitors can be tested for brine compatibility by incubating in a model brine (see, e.g., Table 2) at different temperatures in an anaerobic chamber. A UV/VIS spectrometer can be used to measure the turbidity of the incubated samples to determine brine compatibility. An increase in the absorbance of 0.05 or more at an irradiation wavelength of 500 nm can indicate the formation of pseudo-scale.

The scale inhibitor release profile can be determined by monitoring a Minimum inhibitor concentration (MIC) of the crosslinked polymeric scale inhibitor samples incubated in an anaerobic chamber at different temperatures, over time, using a turbidity method. A decrease in MIC over time indicates the release of more scale inhibitor from the crosslinked scale inhibitor. In some embodiments, the MIC decreases by at least 100 ppm (e.g., at least 75 ppm, at least 50 ppm, at least 20 ppm, or at 1 ppm) and/or at most 3 ppm (e.g., at most 1 ppm, at most 20 ppm, at most 50 ppm, at most 75 ppm) at most over a period of days to months, depending on the temperature.

Treatment lifetimes can be determined using sand pack experiments. The sand pack experiments can be performed in an anaerobic chamber at different temperatures and different brine injection rates to determine the treatment lifetime of the crosslinked polymeric scale inhibitors. In a sand pack experiment, the sand pack is first saturated with the crosslinked polymeric scale inhibitors, model brine is injected at a constant rate and the effluent samples can be collected, the scale inhibitor concentration is measured in the effluent samples, a pressure drop is monitored across the sand pack for signs of plugging by scale (pressure drop increase indicates that a scale inhibitor is losing effectiveness), and the effluent scale inhibitor concentrations and pressure drop is plotted against the pore volumes of the injected brine to determine treatment lifetime. Compared to linear polymeric scale inhibitors having an identical structure (but without crosslinkers), the treatment lifetime of crosslinked polymeric scale inhibitors can be increased by at least 5% (e.g., at least 7%, at least 10%, or at least 15%).

### Method of Use

In use, the scale inhibitor compositions described above can be used to inhibit scale formation in a formation rock in an oil or gas field, by injecting an aqueous suspension of crosslinked polymeric scale inhibitor particles into the formation rock. In some embodiments, before injecting the composition including crosslinked polymeric scale inhibitor particles into the formation rock, the aqueous suspension is diluted with additional liquid. The liquid can be an aqueous solution that includes dissolved inorganic salts, such as brine, or produced fluids.

In some embodiments, the scale-inhibitor chemicals can be continuously injected through a downhole injection point in the completion, or periodic squeeze treatments can be undertaken to place the inhibitor in the reservoir matrix for subsequent commingling with produced fluids. In some embodiments, the scale inhibitors and fracture treatments can be integrated into one step, such that the entire well is treated with scale inhibitor. In this type of treatment, a high-efficiency scale inhibitor is pumped into the matrix surrounding the fracture face during leakoff. The crosslinked polymeric scale inhibitor particles can to the matrix during pumping until the fracture begins to produce water. As water passes through the inhibitor-adsorbed zone, sufficient inhibitor is released to reduce or prevent scale deposition. The inhibitor is better placed than in a conventional scale-inhibitor squeeze, which reduces the retreatment cost and improves production.

### Kits

The present disclosure further provides a kit, including a composition as described above. The composition is configured to inhibit scale formation in a formation rock in an oil and gas field.

### EXAMPLES

### Example 1. Synthesis and Characterizations of Crosslinked Polymeric Scale Inhibitors (SI)

The following is the procedure for preparing a crosslinked polymeric scale inhibitor. The crosslinked polymeric scale inhibitor can be in the form of a gel.

A representative crosslinked polymeric scale inhibitor, hereinafter referred to as 20 mol % AMPS SI gel, was prepared. The 20 mol % AMPS SI gel contained 20 mol % 2-acrylamido-2-methyl-1-propanesulfonic acid sodium salt (AMPS) and 80 mol % acrylic acid (AA) and was synthesized by solution polymerization. The acrylic acid can be substituted in whole or in part with 2-methacrylamido-2-methyl-1-propanesulfonic acid and/or methacrylic acid.

An aqueous solution containing acrylic acid (AA) and 2-acrylamido-2-methyl-1-propanesulfonic acid sodium salt (AMPS, 50%), N,N′-methylene bisacrylamide, thioglycolic acid, 2,2′-azobis(2-methylpropionamidine) dihydrochloride (VAZO 56) in reverse osmosis (“RO”) water was prepared in a 250 ml flask. The amount of reagents used is listed in Table 1.

After pH was adjusted to 3.77 by 10% NaOH, this solution was then purged with nitrogen for 15 minutes and the polymerization was carried out in a 60° C. water bath while stirring. After the crosslinked polymer gel was formed, the gel continued to be incubated at 60° C. and the total reaction time was 2 hours.

In this Example, AMPS was introduced to improve the compatibility of SI with model brine. AMPS content ranged from 5 mol % to 30 mol % of the total monomer amount. N, N′-Methylene bisacrylamide is used as a crosslinker to crosslink linear polymer to form a gel. Thioglycolic acid is used as a chain transfer agent to control polymer molecular weight. VAZO® 56 [2,2′-Azobis(2-methylpropionamidine) dihydrochloride] is a low-temperature, water-soluble polymerization initiator, whose rate of decomposition is first-order and is unaffected by contaminants such as metal ions.

TABLE 1
List of reagents for synthesizing
crosslinked scale inhibitor gel

| Components | Chemicals | Amount, g |
|---|---|---|
| Monomers | Acrylic Acid | 2.19 |
| | 50 wt % AMPS | 3.53 |
| Crosslinker | Methylene | 0.73 |
| | Bisacrylamide | |
| Chain transfer agent | Thioglycolic Acid | 0.29 |
| Solvent | H₂O | 27.92 |
| Initiator | VAZO 56 | 0.33 |
| Buffer | 10 % NaOH _{(aq)} | 4.78 |

### Synthesis of Linear Scale Inhibitor

A linear scale inhibitor was synthesized by the same procedure described above, but without the addition of the crosslinker.

### Preparation of SI Particle

SI particles were prepared by a commercial blender. Crosslinked scale inhibitor gel (calculated SI concentration: 2000 ppm) was blended in an anionic solution using a commercial blender. Particle size was measured until desired size was achieved. SI solution was diluted to a concentration of 1000 ppm SI in a model brine solution containing 50/50 anion and cation. Anion and cation components are presented in Table 2.
1000 ppm solution of scale inhibitor is calculated by the equations below.
   a. Calculate poly(sodium acrylate) (PSA) concentration in gel/solution.

$${( PSA wt . \% )}_{f} = \frac{{m}_{AA} * ( \frac{{MW}_{SA}}{{MW}_{AA}} ) + {m}_{AMPS} ( \frac{{MW}_{SA}}{{MW}_{AMPS}} )}{{m}_{Tot}}$$

b. Dilute with cation for final concentration.

$${( PSA wt . \% )}_{f} = \frac{{m}_{SI solbn .} * {( PSA wt . \% )}_{i}}{{m}_{f}}$$

TABLE 2
Model Brine Recipe

| Anion* | | Cation | |
|---|---|---|---|
| Anion | Wt. (g/Kg) | Cation | Wt. (g/Kg) |
| Na₂SO₄ | 0.931 | MgCl₂*6H₂O | 4.3155 |
| NaCl | 18.3839 | SrCl₂*6H₂O | 0.5899 |
| NaHCO₃ | 0.694 | BaCl₂ | 0.0756 |
| NaAc*3H₂O | 0.5927 | CaCl₂*2H₂O | 7.1894 |
| (sodium acetate | | | |
| trihydrate) | | | |
| | | KCl | 0.5095 |
| | | NaCl | 18.384 |
| Total Dissolved | 20,602 | TDS (ppm) | 31,064 |
| Solids (TDS, in | | | |
| ppm) | | | |

*Anion is prepared beforehand without sodium bicarbonate due to its tendency to break down over time in solution. Sodium bicarbonate is added on the day of use.

### Compatibility Test

Crosslinked SI gels containing 5 to 30 mol % AMPS were used to study compatibility with model brine. The crosslinked SI gels were blended into particle form in a commercial blender, as described above. Then, 5 ml of SI particle solution was transferred into a 6 ml vial with a cap and incubated at 95° C. in an anaerobic chamber overnight. It found that precipitation was observed in SI solution with AMPS content from 0 to 10 mol %, however, no precipitation was observed for crosslinked polymeric particles including 15%-30% AMPS SI, indicating that at least 15 mol % AMPS is needed to achieve the compatibility with model brine. The results were summarized in Table 3.

TABLE 3
Brine Compatibility Results for Various
Scale Inhibitor Compositions.

| Batch | 1 | 2 | 3 | 4 | 5 | 6 |
|---|---|---|---|---|---|---|
| AA, (mol %) | 100 | 90 | 85 | 80 | 75 | 70 |
| AMPS, (mol %) | 0 | 10 | 15 | 20 | 25 | 30 |
| Compatibility with | No | No | Yes | Yes | Yes | Yes |
| model brine | | | | | | |

### Test of Minimum Inhibition Concentration (MIC)

MIC of SI is tested by measuring the turbidity of the solutions after incubation at high temperatures, while stirring. The mixtures of model brine with different concentration of SI were incubated at high temperature. When SI content is below MIC, the scale would form and the sample solution turbidity would be observed. A UV-Vis Spectrophotometer was used to measure the turbidity of sample solution at 500 nm.

Several samples were incubated at high temperatures and anaerobic conditions. Samples were periodically removed for analysis, and aggregation of the data yield the release profile. High temperatures would lead to the release of SI from the crosslinked particle due to hydrolysis of the crosslinked particle, and the decrease in the MIC over time would function as an indication of the release of more scale inhibitor from the cross-linked polymer.

1000 ppm of scale inhibitor in model brine was prepared by the procedure above and was divided into vials in an oxygen-free glove box. The vials were incubated at 95° C. (e.g., in an incubation oven) for various lengths of time before measuring MIC.

At selected intervals (e.g., once each week), one vial was taken out from the incubation oven for MIC test. SI solution was diluted into different concentrations in model brine, as shown in Table 4. 5 ml of model brine with different SI was transferred into 6 ml vials with stirring bars and caps, and incubated in a 95° C. water bath while stirring at 700 rpm. After two hours incubation, the absorbance was measured to determine MIC at 500 nm by a UV-Vis Spectrophotometer.

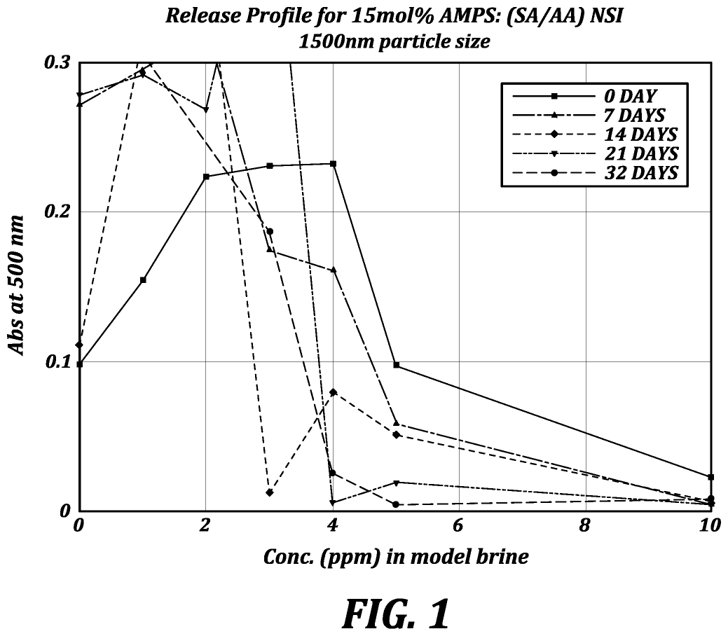

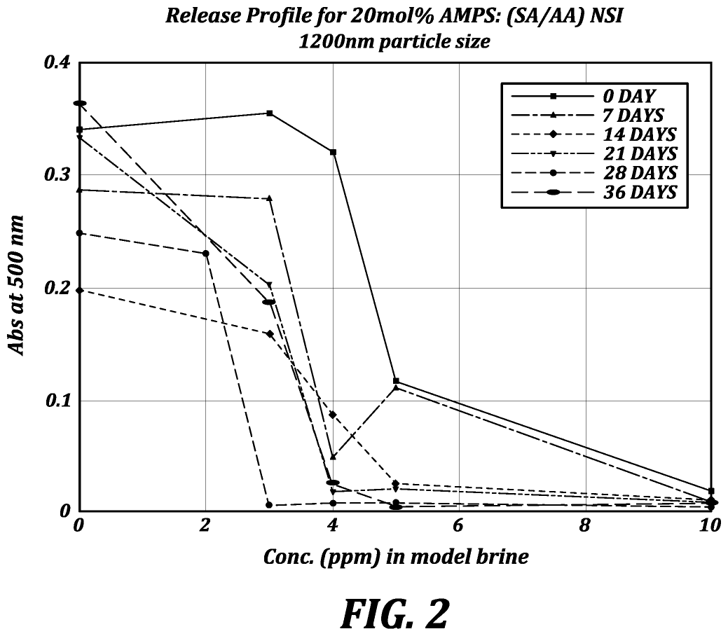

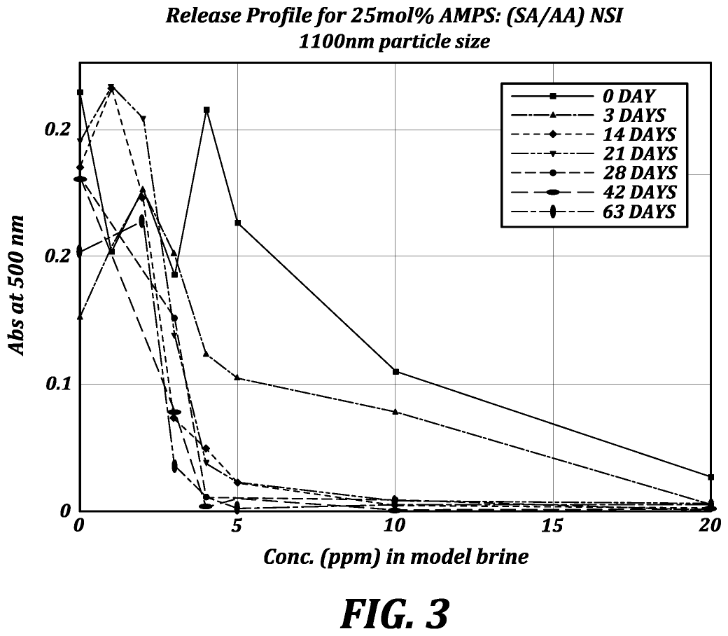

The results are shown in FIGS. 1, 2 and 3, and demonstrate that the MIC of all three batches decreased with incubation time at 95° C.

TABLE 4
MIC Sample Preparation

| Desired SI | | Desired |
|---|---|---|
| concentration (ppm) | Components | volume (ml) |
| 100 | 100 ppm | 5.00 |
| 50 | 100 ppm SI solution. | 2.50 |
| | Anion | 1.25 |
| | Cation | 1.25 |
| 10 | 20 ppm SI solution | 2.50 |
| | Anion | 1.25 |
| | Cation | 1.25 |
| 5 | 5 PPm | 5.00 |
| 4 | 20 ppm SI solution | 1.00 |
| | Anion | 2.00 |
| | Cation | 2.00 |
| 3 | 5 ppm SI solution | 3.00 |
| | Anion | 1.00 |
| | Cation | 1.00 |
| 2 | 5 ppm SI solution | 2.00 |
| | Anion | 1.50 |
| | Cation | 1.50 |
| 1 | 5 ppm SI solution | 1.00 |
| | Anion | 2.00 |
| | Cation | 2.00 |
| 0 | Anion | 2.50 |
| | Cation | 2.50 |

### Dynamic Retention Test

Dynamic retention of SI particle was studied in quartz sand. A sand pack was prepared with the quartz sand (100 mesh) in a glass column (14.12 in length, 0.69 in inner diameter). The pore volume (PV) of the sand pack was ˜30 ml and its porosity was about ˜35%. The procedure is described in detail below.

3 PV of SI particle solution in model brine was injected into the sand pack at 45° C. at a rate of 0.4 ml/min (˜6 ft/day). The sand pack was shut in overnight at 45° C. Then, the sand pack was flushed, including 3 PV of model brine in a forward direction at the rate of 0.2 mL/min (3 ft/day) and 3 PV of model brine in an inverse direction at the rate of 0.2 mL/min (3 ft/day), respectively.

All the effluents were collected. The total nitrogen content of the effluents and the injected SI particle solution was measured by a total organic carbon-total nitrogen (TOC-TN) analyzer and used to calculate the amount of SI retained in the sand pack via mass balance, as shown in the equation below.

SI retained in sand pack=total SI injected−total SI in effluents

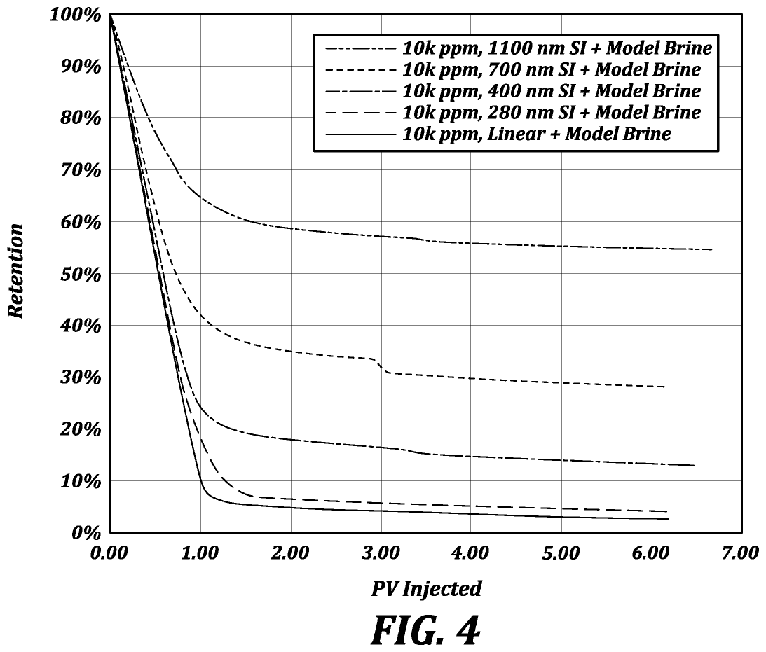

The retention of SI particle with different size in sand pack was summarized in FIG. 4, which shows that SI percent retention increased with increasing SI particle size.

While illustrative embodiments have been illustrated and described, it will be appreciated that various changes can be made therein without departing from the spirit and scope of the invention.

1. A composition, comprising:
a liquid; and
crosslinked polymeric scale inhibitor particles suspended in the liquid,
wherein the crosslinked polymeric scale inhibitor particles comprise:
a polymer synthesized from at least a monomer selected from (alkyl)acrylic acid monomers, hydroxyalkyl (alkyl)acrylate phosphonate monomers, hydroxyalkyl (alkyl)acrylate phosphate monomers, α,β-unsaturated carboxylic acids, α,β-unsaturated esters, α,β-unsaturated anhydrides, brine-compatible monomers, salts thereof, and any combination thereof; and
a crosslinker linked to the polymer via hydrolyzable bonds,
wherein the composition is configured to inhibit scale formation in a formation rock in an oil and gas field.

2. The composition of claim 1, wherein the particles have an average maximum dimension of 1 nm to 100 μm.

3. The composition of claim 1, wherein the liquid comprises water.

4. The composition of claim 1, wherein the liquid comprises dissolved inorganic salts.

5. The composition of claim 1, wherein the liquid is brine.

6. The composition of claim 1, wherein:
the (alkyl)acrylic acid monomers and salts thereof are selected from acrylic acid, methacrylic acid, sodium acrylate, sodium methacrylate, ethylacrylic acid, sodium ethylacrylate, and any combination thereof;
the hydroxyalkyl (alkyl)acrylate phosphate is selected from 2-hydroxyethyl acrylate phosphate, 2-hydroxyethyl methacrylate phosphate), and any combination thereof;
the α,β-unsaturated carboxylic acids are selected from maleic acid, salts thereof, and combinations thereof;
the brine-compatible monomers are each independently selected from monomers comprising sulfonic acid groups, hydroxyl functional groups, sulfate groups, ethylene glycol, and any combination thereof; or
the crosslinker is selected from methylene bis(meth)acrylamide, poly(ethylene glycol) di(meth)acrylate, di(meth)acrylamide, poly(ethylene glycol) diacrylamide, dimethacrylamide, and any combination thereof.

7-8. (canceled)

9. The composition of claim 1, wherein the α,β-unsaturated anhydride is maleic anhydride.

10. (canceled)

11. The composition of claim 1, wherein the brine-compatible monomers and salts thereof are each independently selected from 2-(alkyl)acrylamide-2-methyl-1-propanesulfonic acid, sodium 2-(alkyl)acrylamido-2-methyl-1-propanesulfonate, 2-acrylamido-2-methyl-1-propanesulfonic acid, sodium 2-acrylamido-2-methyl-1-propanesulfonate, methallyl sulfonic acid, 3-allyloxyl-2-hydroxypropanesulfonic acid, 4-(allyloxy)benzenesulfonic acid, para styrene sulfonic acid, salts thereof, and any combination thereof.

12. (canceled)

13. The composition of claim 1, consisting essentially of the liquid and crosslinked polymeric scale inhibitor particles suspended in the liquid, and optionally one or more dissolved salts in the liquid.

14. The composition of claim 1, further comprising a linear polymer synthesized from (alkyl)acrylic acid monomers, brine-compatible monomers, salts thereof, and any combination thereof.

15. A method of inhibiting scale formation in a formation rock in an oil or gas field, comprising:
injecting an aqueous suspension of crosslinked polymeric scale inhibitor particles into the formation rock,
wherein the crosslinked polymeric scale inhibitor comprises:
a polymer synthesized from at least a monomer selected from (alkyl)acrylic acid monomers, hydroxyalkyl (alkyl)acrylate phosphonate monomers, hydroxyalkyl (alkyl)acrylate phosphate monomers, α,β-unsaturated carboxylic acids, α,β-unsaturated esters, α,β-unsaturated anhydrides, brine-compatible monomers, salts thereof, and any combination thereof; and
a crosslinker linked to the polymer via hydrolyzable bonds,
wherein the aqueous suspension inhibits scale formation in the formation rock in the oil and gas field.

16. The method of claim 15, further comprising diluting the aqueous suspension before injecting the crosslinked polymeric scale inhibitor particles into the formation rock.

17. The method of claim 15, wherein the particles have an average maximum dimension of 1 nm to 100 μm.

18. The method of claim 15, wherein the aqueous suspension comprises dissolved inorganic salts.

19. The method of claim 15, wherein the aqueous suspension comprises brine.

20. The method of claim 15, wherein:
the (alkyl)acrylic acid monomers and salts thereof are selected from acrylic acid, methacrylic acid, sodium acrylate, sodium methacrylate, ethylacrylic acid, sodium ethylacrylate, and any combination thereof;
the hydroxyalkyl (alkyl)acrylate phosphate is selected from 2-hydroxyethyl acrylate phosphate, 2-hydroxyethyl methacrylate phosphate), and any combination thereof;
the α,β-unsaturated carboxylic acids are selected from maleic acid, salts thereof, and combinations thereof;
the brine-compatible monomers and salts thereof, are each independently selected from monomers comprising sulfonic acid groups, hydroxyl functional groups, sulfate functional groups, ethylene glycol, and any combination thereof;
the crosslinker is selected from methylene bis(meth)acrylamide, poly(ethylene glycol) di(meth)acrylate, di(meth)acrylamide, poly(ethylene glycol) diacrylamide, poly(ethylene glycol) dimethacrylamide, and any combination thereof.

21-22. (canceled)

23. The method of claim 15, wherein the α,β-unsaturated anhydride is maleic anhydride.

24. (canceled)

25. The method of claim 15, wherein the brine-compatible monomers and salts thereof, are each independently selected from 2-(alkyl)acrylamide-2-methyl-1-propanesulfonic acid, sodium 2-(alkyl)acrylamido-2-methyl-1-propanesulfonate, 2-acrylamido-2-methyl-1-propanesulfonic acid, sodium 2-acrylamido-2-methyl-1-propanesulfonate, methallyl sulfonic acid, 3-allyloxyl-2-hydroxypropanesulfonic acid, 4-(allyloxy)benzenesulfonic acid, para styrene sulfonic acid, salts thereof, and any combination thereof.

26. (canceled)

27. The method of claim 15, wherein the aqueous suspension further comprises a linear polymer synthesized from (alkyl)acrylic acid monomers, brine-compatible monomers, salts thereof, and any combination thereof.

28. A kit, comprising
a composition comprising a liquid; and crosslinked polymeric scale inhibitor particles suspended in the liquid,
wherein the crosslinked polymeric scale inhibitor particles comprises:
a polymer synthesized from at least a monomer selected from (alkyl)acrylic acid monomers, α,β-unsaturated carboxylic acids, α,β-unsaturated esters, α,β-unsaturated anhydrides, brine-compatible monomers, salts thereof, and any combination thereof; and
a crosslinker linked to the polymer via hydrolyzable bonds,
wherein the composition is configured to inhibit scale formation in a formation rock in an oil and gas field.
